(19) United States
(12) Patent Application Publication
(10) Pub. No.: US 2025/0237441 A1
(43) Pub. Date: Jul. 24, 2025

(54) ENERGY STORING DEVICE

(71) Applicant: HONDA MOTOR CO., LTD., Tokyo (JP)

(72) Inventors: Naoto ISHII, Saitama (JP); Hiroko KIMOTO, Saitama (JP); Takanori NUMANYU, Saitama (JP); Tomoya WATANABE, Saitama (JP)

(21) Appl. No.: 19/026,455

(22) Filed: Jan. 17, 2025

(30) Foreign Application Priority Data
Jan. 24, 2024 (JP) 2024-008924

(51) Int. Cl. F28D 20/00

(52) U.S. Cl. CPC F28D 20/003; F28D 2020/0082

(57) ABSTRACT

An energy storing device is provided which is capable of efficiently utilizing energy. A container in an energy storing device which generates heat by chemical reaction of a thermal storage material accommodated inside of each container is a double wall container including an inside wall and an outside wall, in which a pair of containers is configured by a heat-generating-side container in which the thermal storage material generates heat, and a regenerating-side container which regenerates the thermal storage material used in heat generation, in which the pair of containers are connected by piping in which an ejector is provided.

This application is based on and claims the benefit of priority from Japanese Patent Application No. 2024-008924, filed on 24 Jan. 2024, the content of which is incorporated herein by reference.

### BACKGROUND OF THE INVENTION

### Field of the Invention

The present invention relates to an energy storing device.

### Related Art

Conventionally, solar and wind power generation have been known as renewable energies for mitigating global warming. Since it may be difficult for renewable energy to stabilize the power supply, energy storage is being carried out using various types of batteries. To repeatably regenerate energy, an energy storing device by way of chemical heat storage using chemical reaction heat has been known. In order to improve such chemical reactions or thermal efficiency, it has been proposed to arrange, inside a flow channel which has been reduced in pressure using a vacuum pump or like, a container after exothermic reaction which retains a thermal storage material inside (for example, refer to Japanese Unexamined Patent Application, Publication No. 2016-118315).
Patent Document 1: Japanese Unexamined Patent Application, Publication No. 2016-118315

### SUMMARY OF THE INVENTION

Separate energy is necessary to employ a vacuum pump. In addition, with the technology disclosed in Japanese Unexamined Patent Application, Publication No. 2016-118315, due to arranging the entire container in a reduced pressure flow channel, it is difficult to make the individual reactions efficient. In this way, there has been a problem in that energy is unlikely to the efficiently used.

A first aspect of the present invention relates to an energy storing device (for example, the energy storing device 1) including a container (for example, the container 10a) and a thermal storage material (for example, the thermal storage material 3) that is accommodated inside of the container (for example, the container 10a) and generates heat by way of chemical reaction, in which the container includes a pair of containers (for example, the pair of containers 10), each one being configured by double walls including an inside wall (for example, the inside wall 111) and an outside wall (for example, the outside wall 112), the pair of containers including a heat-generating-side container (for example, the heat-generating-side container 11) in which the thermal storage material generates heat, and a regenerating-side container (for example, the regenerating-side container 12) which regenerates the thermal storage material used in heat generation, and in which the pair of containers are connected by piping (for example, the piping 9) in which an ejector (for example, the ejector 4) is provided.

According to a second aspect of the present invention, it is preferable to further include: a steam channel (for example, the steam channel 43) in which steam generated by the heat-generating-side container flows, and the ejector is provided; and a negative-pressure first channel (for example, the negative-pressure first channel 41) which is connected from the ejector to inside of the regenerating-side container, in which air inside of the regenerating-side container is suctioned from the negative-pressure first channel to reduce in pressure by negative pressure generated by venturi effect of the ejector.

According to a third aspect of the present invention, it is preferable to further include: a steam channel in which steam generated by the heat-generating-side container flows, and in which the ejector is provided; a check valve (for example, the check valve 45) disposed in a vicinity of the ejector; and a negative-pressure second channel (for example, the negative-pressure second channel 42) which is connected from the ejector to between the inside wall and the outside wall of each of the pair of containers via the check valve, in which air within the double walls of the container is suctioned from the negative-pressure second channel to reduce in pressure by negative pressure generated by venturi effect of the ejector.

According to a fourth aspect of the present invention, it is preferable for the thermal storage material to be an alkali earth metal, the thermal storage material to generate heat in the heat-generating-side container by water being supplied thereto, whereby the regenerating-side container is heated, and a hydroxide of the alkali-earth metal is oxidized to regenerate the thermal storage material, the energy storing device to further include a regeneration steam channel (for example, the regeneration steam channel 44) which connects between the heat-generating-side container and the regenerating-side container, and in which steam generated from the regenerating-side container flows, and the ejector is provided, and steam to be suctioned from the regenerating-side container to the heat-generating-side container by negative pressure generated by venturi effect of the ejector, and supplied to the heat-generating-side container.

According to a fifth aspect of the present invention, it is preferable for the thermal storage material to be a metal oxide which reacts with water, and heating and supply of water to the pair of containers to be switched so that the heat-generating-side container and the regenerating-side container alternately change roles.

According to a sixth aspect of the present invention, it is preferable to further include a water pipe section (for example, the water pipe section 5) disposed in each of the pair of containers, and capable of flowing water or hot water and steam inside, in which, during regeneration of the thermal storage material, supply of water to the water pipe section is not performed in the regenerating-side container, and hot water or steam within the water pipe section is supplied to the water pipe section of the heat-generating-side container.

A seventh aspect of the present invention relates to a method of producing the energy storing device as described in the first or second aspect, in which the inside wall and the outside wall of the double walls are joined with atmospheric pressure therebetween.

According to the above first aspect, since the heat-generating-side container and the regenerating-side container are connected by piping in which the ejector is provided, upon reducing the pressure in the regenerating-side container, it is possible to use the air flow of steam produced from the heat-generating-side container to reduce the pressure. For this reason, since an electric vacuum pump and the like are unnecessary, and it is inexpensive and will not break, it is possible to easily reduce the pressure in the regenerating-side container. In addition, the chemical reaction is prompted in one direction by the reducing the pressure of the regenerating-side container, whereby oxidation is promoted, and it is possible to reduce the energy required in the regeneration of the thermal storage material.

According to the above second aspect, since it is possible to carry out pressure reduction of the regenerating-side container with the negative pressure from the venturi effect of the ejector, an electric vacuum pump and the like are unnecessary, and it is inexpensive and will not break, and thus it is possible to easily reduce the pressure in the regenerating-side container.

According to the above third aspect, since it is possible to carry out pressure reduction between the inside wall and the outside wall with the negative pressure from the venturi effect of the ejector 4, an electric vacuum pump and the like are unnecessary, and it is inexpensive and will not break, and thus it is possible to easily reduce the pressure in the regenerating-side container. In addition, since it is possible reduce the pressure between the double walls and maintain a substantially vacuum state, there is a high insulation property and thermal efficiency becomes favorable. Consequently, a thermal insulator is unnecessary in the pair of containers 10, which facilitates recycling, etc., and thus the environmental impact is reduced.

According to the above fourth aspect, the steam generated by the endothermic reaction of the thermal storage material 3 inside the regenerating-side container 12 is reduced in pressure and suctioned by the ejector 4. Since the steam generated during regeneration of the thermal storage material 3 is emitted to outside the regenerating-side container 12, the thermal energy required in regeneration becomes smaller, and the temperature required in regeneration also becomes lower. In addition, it is also possible to shorten the time required in regeneration. Furthermore, by the air and/or steam inside of the regenerating-side container 12 being reduced in pressure by the ejector 4, the heat loss of the heated regenerating-side container 12 decreases.

According to the above fifth aspect, by alternately switching the heat-generating-side container and the regenerating-side container, it becomes possible to regenerate and store energy continuously.

According to the above sixth aspect, the water within the water pipe section heated during regeneration becomes steam, which is supplied to the water pipe section 5 of the heat-generating-side container 11, whereby it is possible to utilize the heat without waste.

According to the above seventh aspect, in the case of each of the pair of containers being large scale, since it is unnecessary to produce a vacuum double-walled container by welding in a reduced pressure substantially vacuum environment, it becomes possible to reduce the production cost. There is no need to spend a long time vacuuming inside of the welded vacuum double-walled container.

### BRIEF DESCRIPTION OF THE DRAWINGS

FIG. 1 is a schematic diagram showing an energy storing device according to the present embodiment;

FIG. 2A is a perspective view showing one of a pair of containers according to the present embodiment;

FIG. 2B is a perspective cross-sectional view for explaining the inside of one of the pair of containers according to the present embodiment;

FIG. 2C is a perspective view showing a water pipe section and thermal units inside of one of the pair of containers according to the present embodiment; and

FIG. 3 is a schematic diagram for explaining the thermal heat unit according to the present embodiment.

### DETAILED DESCRIPTION OF THE INVENTION

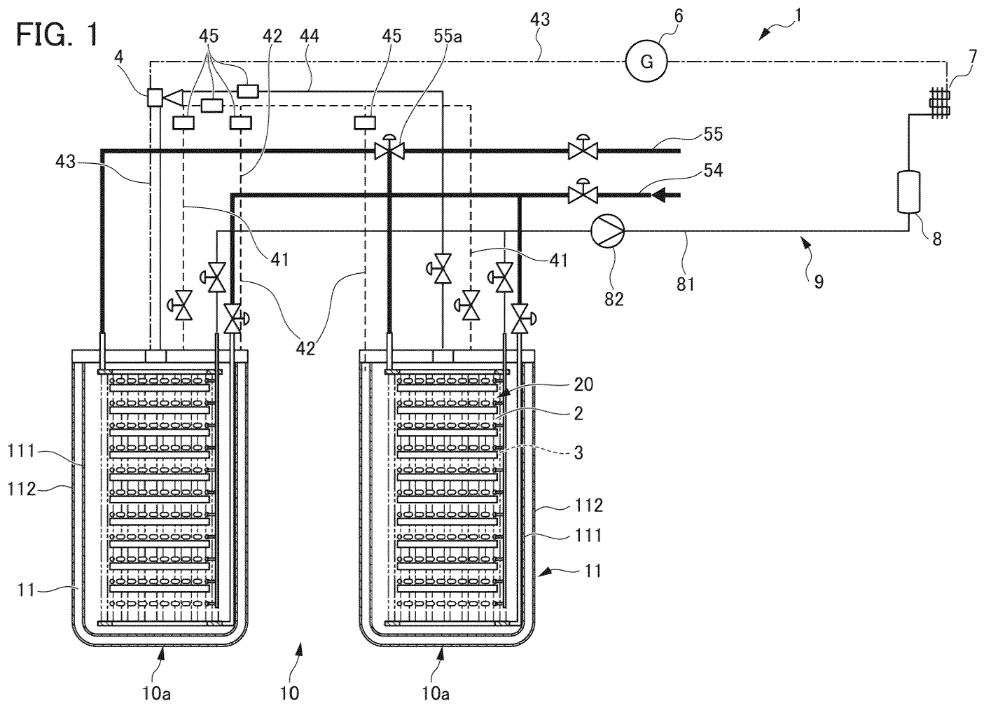

Hereinafter, an embodiment of the present invention will be described in detail while referencing the drawings. An energy storing device 1 according to the present embodiment is a device which circulates and stores energy by chemical heat storage. The energy storing device 1 generates heat by chemical reaction of a thermal storage material 3 accommodated inside of a pair of containers 10 configured by two containers 10a. As shown in FIG. 1, the energy storing device 1 has the pair of the containers 10, the thermal storage material 3, a reactor 2, an ejector 4, a water pipe section 5, a generator 6, a steam condenser 7, a tank 8, and piping 9. In addition, the energy storing device 1 has a steam channel 43, a negative-pressure first channel 41, a negative-pressure second channel 42, and a regeneration steam channel 44 which are configured by the piping 9.

The thermal storage material 3 is a chemical substance which separates into a thermal storage product and a product fluid during heating, and emits heat by the reverse reaction. For example, the thermal storage material 3 is an alkali earth metal, and reacts with water. More specifically, calcium oxide (CaO), steam (H₂O), and magnesium oxide (MgO) and steam (H₂O), etc. can be exemplified, and an example will be describe with calcium oxide and steam in the present embodiment.

The pair of containers 10 includes a heat-generating-side container 11 in which the thermal storage material 3 generates heat, and a regenerating-side container 12 which regenerates the thermal storage material 3 used in heat generation. The heat-generating-side container 11 and regenerating-side container 12 have the same configuration, and are used by the heating and supply of water being switched so as to alternate roles with each other. In the heat-generating-side container 11, water and/or steam are supplied, and the thermal storage material 3 generates heat, whereby the regenerating-side container 12 is heated and the thermal storage material 3 is regenerated. The pair of containers 10 are connected by the piping 9. The piping 9 is configured by pipe constituting the respective the flow channels in which water, hot water, steam, etc. described later flow.

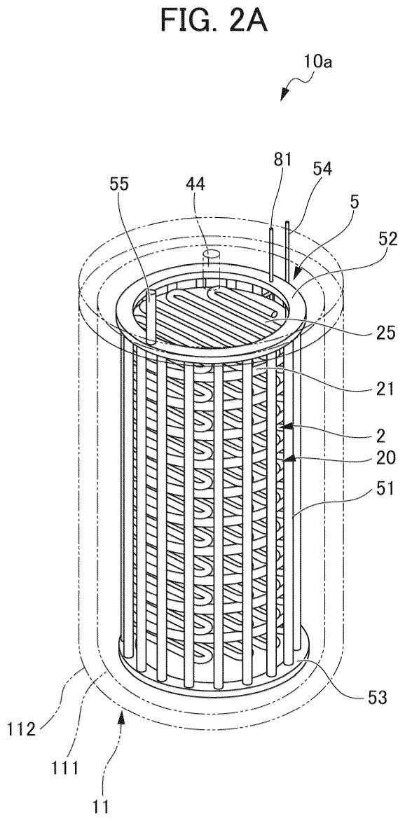

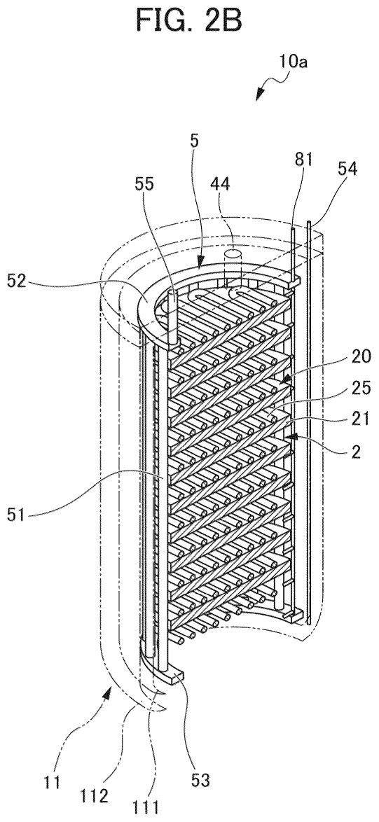

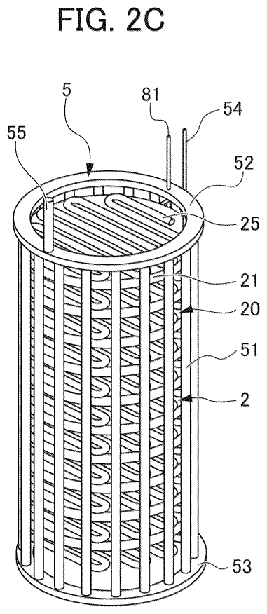

In the pair of containers 10, as shown in FIG. 2A and FIG. 2B, each of the containers 10a is configured by double walls including an inside wall 111 and an outside wall 112. The container 10a is made of metal, for example, and has a space which can accommodate the reactor 2 described later inside thereof. The inside wall 111 is arranged on the inner side of the container 10a, and the outside wall 112 is arranged on the outer side of the container 10a. The space is formed between the inside wall 111 and the outside wall 112, and the space is reduced in pressure so that inside approaches vacuum during operation of the energy storing device 1.

During manufacture, between the inside wall 111 and the outside wall 112 are joined together with atmospheric pressure. The inside wall 111 and the outside wall 112 are assembled and joined by a known method such as fastening by fastening members such as screws and bolts, and arranging a sealing member therebetween; however, they are not joined by welding. As the formation method of the double walls without welding, for example, it may be done by forming a flange portion (not shown) in an upper end of the inside wall 111 and an upper end of the outside wall 112 so that they overlap each other, and sealing the flange portion of the inside wall 111 and the flange portion of the outside wall 112 and fastening by bolts. The flange portion may form so as to extend from the upper end of a lateral surface of the container 10a to the outer side of the circumferential direction, or may form so as to curve from the upper end of a lateral surface of the container 10a to the inner side. In addition, a joint may be sealed by bending the upper end of the inside wall 111 and the upper end of the outside wall 112 so as to approach each other. Furthermore, a lid 113 is arranged on the double-wall container 10a. The lid 113 may be fixed by bolts or the like to a portion at which the flange portions of the inside wall 111 and outside wall 112 overlap. By joining the inside wall 111 and outside wall 112 without joining by welding, using a method other than welding, in the case of each of the pair of containers 10 being large scale, since it is unnecessary to produce a vacuum double-wall container by welding in a reduced pressure almost vacuum environment, it becomes possible to reduce the production cost.

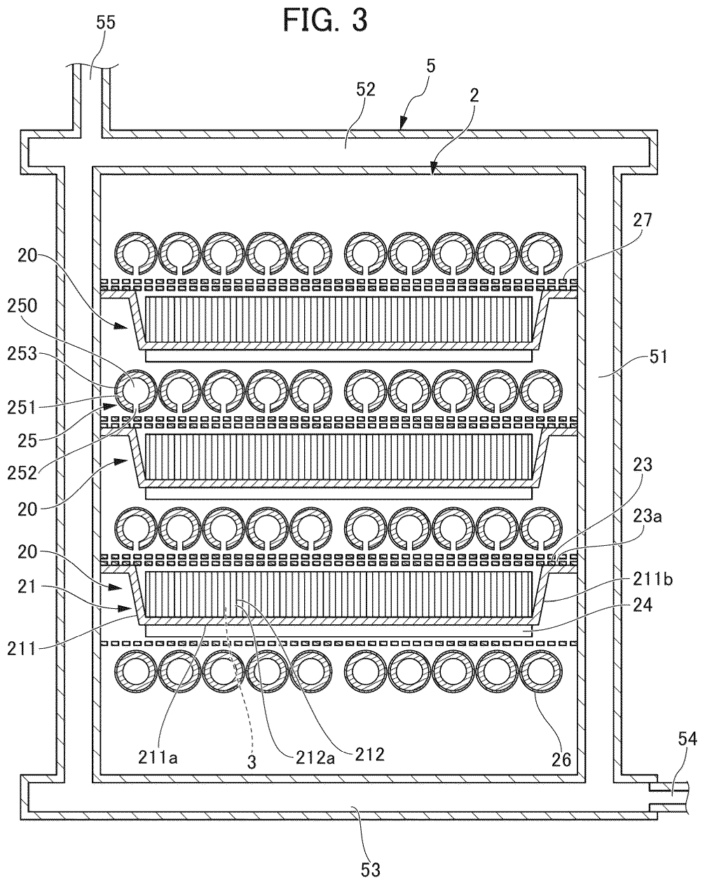

As shown in FIGS. 2A to 2C and 3, the reactor 2 has a plurality of thermal units 20 which cause chemical reaction. The reactor 2 is arranged in the same configuration in each of the heat-generating-side container 11 and regenerating-side container 12. The reactor 2 causes an exothermic reaction by water being supplied to calcium oxide in the heat-generating-side container 11, and causes an endothermic reaction by heating the calcium hydroxide in the regenerating-side container 12.

As shown in FIG. 3, the thermal units 20 are arranged so that each one can be separated and replaced. Each of the thermal units 20 includes a metal container 21, the thermal storage material 3, a lid member 23, a heating member 24, and a pipe member 25.

The metal container 21 has a container main body 211, and a plurality of storage chambers 212. The container main body 211 is a shallow dish-shaped container with an open top, and has a bottom 211a and lateral wall 211b. The metal container 21 is formed from a metal made of a magnetic metal. More specifically, the metal container 21 is configured from a stainless steel having magnetism. The plurality of storage chambers 212 is configured from a metallic honeycomb structure. By the honeycomb structure being made of metal, it will generate heat through electromagnet induction heating. The honeycomb structure is arranged so that partitions 212a extend in the vertical direction from the bottom to the top opening, in a state placed in the container main body 211, and the space divided into multiple parts by the partitions 212a constitutes the storage chambers 212. The height of the partitions 212a does not exceed the height of the container main body 211, and is configured so as to be lower than the upper end of the lateral wall 211b of the container main body 211.

The thermal storage material 3 is configured by calcium oxide being formed in granular shape. The thermal storage material 3 is filled to be accommodated in the storage chambers 212 of the metal container 21. The granular material includes particulates irrespective of the size of grains, such as granules and powders, and may be any form.

The lid member 23 is provided at the upper part of the metal container 21, and is a cover made of metal which covers the metal container 21. The lid member 23 has a through hole 23a which can pass steam therethrough upwards and downwards. The specific shape of the lid member 23 may be netlike, or may be a perforated metal in which circular holes are formed in a flat plate.

The heating member 24 is a plate-like member provided to the lower part of the metal container 21. The heating member 24 heats the bottom 211a of the metal container 21 by an induction heater. The heating member 24 is heated by electrification to rise in temperature.

The pipe member 25 is a cylindrical body made of non-magnetic metal provided at the upper part of the lid member 23. More specifically, it is a copper pipe. The pipe member 25, at the same time as being a water supply pipe in which a running water channel 250 in which water flows is formed inside, is also a tube in which an induction coil for heating is integrated. As shown in FIG. 3, when the thermal units 20 are arranged to overlap vertically, the bottom 211a of the metal container 21 is arranged above the pipe members 25, and the lid member 23 is arranged below the pipe members 25. Between the pipe member 25 and the metal container 21, an insulation plate 27 is provided so that the pipe members 25 do not directly contact the metal container 21. The insulation plate 27 has through holes, and can be made from ceramic, glass or the like having insulation and heat resistance properties. As another configuration which insulates metal container 21 and the pipe members 25, in addition to the insulation plate 27, it is also possible to place a mat (nonwoven fabric), cloth (woven fabric) or sheet having water permeability which can be made from glass fiber or ceramic fiber on the upper surface of the lid member having through holes. The pipe member 25 has a pipe main body 251, a drip part 252, and an induction coil part 253.

The pipe main body 251 has a tubular shape, and is arranged so as to cover the lid member 23 by a plurality of the pipe main body being adjacent with each other, as shown in FIGS. 2A to 2C. The pipe main body 251 extends in a direction such that the longitudinal direction thereof follows the upper surface or the lower surface of the metal container 21.

The drip part 252 is a slit provided in the pipe main body 251 on the side of the lid member 23, i.e. in the lower part. Regarding the drip part 252, upon water flowing inside of the pipe main body 251, water drips down from the drip part 252 formed in the lower part, and drops to the metal container 21 positioned below.

The induction coil part 253 is a copper wire wound in a coil shape on the surface of the pipe main body 251. The induction coil part 253 is integrated with the pipe main body 251. The pipe main body 251 and the induction coil part 253 are both heated to heat the thermal storage material 3.

The electricity for heating of the reactor 2 described above may employ renewable energy such as solar power and wind power. By operating the energy storing device 1 while employing renewable energy, it becomes possible to use unstable supply of electricity in the production of other energy, and to store it.

The ejector 4 is provided to the piping 9, as shown in FIG. 1. The ejector 4 suctions the high pressure steam supplied from the heat-generating-side container 11, and causes negative pressure to occur from the venturi effect. The effector 4 is provided to the steam channel 43 described later.

The steam channel 43 is the piping 9 connected to the pair of containers 10, and upon one of the pair of containers 10 functioning as the heat-generating-side container 11, is a flow channel in which the steam generated by the heat-generating-side container 11 flows. The steam channel 43, as shown in FIG. 1, has the ejector 4 provided thereto, and is connected to the generator 6 and the steam condenser 7. In FIGS. 2A and 2B, the steam channel 43 is omitted. Although not illustrated in FIG. 1, the steam channel 43 may extend from the right-side container 10, when the right-side container 10a in FIG. 1 functions as the heat-generating-side container 11.

The negative-pressure first channel 41 is the piping 9 connected from the ejector 4 to the inside of the regenerating-side container 12 via a check valve 45 arranged near the ejector 4. In the negative-pressure first channel 41, the air within the regenerating-side container 12 is suctioned by the negative pressure generated by the venturi effect of the ejector 4 to reduce in pressure. Inside of the regenerating-side container 12 is reduced in pressure, and heated, whereby the calcium hydroxide (Ca(OH)₂) is regenerated to calcium oxide (CaO).

The negative-pressure second channel 42 is the piping 9 connected from the ejector 4 to between the inside wall 111 and the outside wall 112 of each of the pair of container 10 via the check valve 45 arranged near the ejector 4. In the negative-pressure second channel 42, the air within the double walls of each container 10a is suctioned by the negative pressure generated by the venturi effect of the ejector 4 to reduce the pressure.

The regeneration steam channel 44 is piping which connects the heat-generating-side container 11 and the regenerating-side container 12. The ejector 4 is provided in the regeneration steam channel 44 as shown in FIG. 1, and the steam within the regenerating-side container 12 is suctioned by the negative pressure generated by the venturi effect of the ejector 4, and the suctioned steam is supplied to the heat-generating-side container 11.

The generator 6 is arranged downstream of the steam channel 43 and the ejector 4. The generator 6 performs power generation using the steam generated by the thermal units 20. The type of generator 6 is not particularly limited so long as being able to utilize the steam and heat, pressure, etc. For example, it may be a steam turbine, a screw-type generator or the like. In addition, it may not only be a device which generates power by directly employing steam, but also one using heat such as a thermoelectric element or Stirling engine. In addition, power generation may be performed from the energy upon decompressing the steam.

The steam condenser 7 is arranged downstream of the generator 6. The steam condenser 7 cools to condense the steam generated by the thermal units 20, or steam used in power generation to condense into water. In the steam condenser 7, impurities such as carbon dioxide included in the steam, etc. are removed to produce pure water, which can be supplied to the thermal units 20.

The tank 8 is a sealed container which stores the water condensed by the steam condenser 7. A thermal unit water supply channel 81 which supplies water to the thermal units 20 extends from the tank 8.

The thermal unit water supply channel 81 is connected to each of the thermal units 20 of the pair of containers 10. A pump 82 is arranged in the thermal unit water supply channel 81, and upon one of the pair of containers 10 being used as the heat-generating-side container 11, supplies water to the thermal units 20 of the heat-generating-side container 11. The thermal unit water supply channel 81 communicates with the running water channels 250 of the pipe members 25 of the thermal units 20. By supplying the pure water returned by the steam condenser 7 to the thermal units 20, the unintended generation of calcium carbonate or the like is suppressed.

The water pipe section 5, as shown in FIGS. 2A to 2C, is arranged on the inside of each of the pair of containers 10 at the periphery of the thermal units 20, and water, hot water, steam and the like flow inside.

The water pipe section 5 has a vertical pipe 51, an upper annular portion 52, and a lower annular portion 53. A plurality of the vertical pipes 51 is arranged so as to surround the periphery of the thermal units 20. The vertical pipes 51 are arranged so that the longitudinal direction of the substantially cylindrical tube extends along the vertical direction, and are arranged to align at the periphery of the thermal units 20 so as to be substantially annular in a plan view. The upper annular portion 52 is an annular member coupling the upper ends of a plurality of the vertical tubes 51, and the inside thereof is configured to be hollow. The lower annular portion 53 is an annular member coupling the lower ends of a plurality of vertical tubes 51, and the inside thereof is configured to be hollow. The upper annular portion 52, lower annular portion 53 and vertical tubes 51 communicate internally, and fluid can migrate inside of each.

The water pipe section 5 is connected to a water supply source such as public water, and can supply water from the public water to inside via the water supply channel 54. In addition, the water pipe section 5, by the pair of containers 10 and thermal units 20 being heated, the temperature elevates, and the water inside thereof becomes hot water or steam. The elevated hot water or steam may be discharged from the water pipe section 5 via a warm water channel 55, and used. In addition, by not performing the supply of water to the water pipe section 5 while performing regeneration of the thermal storage material 3 in the regenerating-side container 12, and providing the valve 55a, etc. to the warm water channel 55, and forming a flow channel for supply, the hot water or steam in the water pipe section 5 is supplied to the water pipe section 5 of the heat-generating-side container 11.

According to the present embodiment, the following effects are exerted.

(1) In the energy storing device 1 including the container 10a and the thermal storage material 3 that is housed inside of the container 10a and generates heat by chemical reaction, the container 10a is configured by double walls including the inside wall 111 and the outside wall 112. The pair of containers 10 is configured by the heat-generating-side container 11 in which the thermal storage material 3 generates heat, and the regenerating-side container 12 which regenerates the thermal storage material 3 used in heat generation. The pair of containers 10 is connected by the piping 9 in which the ejector 4 is provided. Since the heat-generating-side container 11 and the regenerating-side container 12 are connected by the piping 9 in which the ejector 4 is provided, upon reducing the pressure in the regenerating-side container 12, it is possible to use the airflow of steam produced from the heat-generating-side container 11 to reduce pressure. For this reason, since an electric vacuum pump and the like are unnecessary, and it is inexpensive and will not break, it is possible to easily reduce the pressure in the regenerating-side container 12. In addition, the chemical reaction is prompted in one direction by the reducing the pressure of the regenerating-side container 12, whereby oxidation is promoted, and it is possible to reduce the energy required in the regeneration of the thermal storage material 3.

(2) The present embodiment is configured to include the steam channel 43 in which the steam generated in the heat-generating-side container 11 flows, and in which the ejector 4 is provided, and the negative-pressure first channel 41 connected from the ejector 4 to the inside of the regenerating-side container 12. The air within the regenerating-side container 12 is suctioned from the negative-pressure first channel 41 by the negative pressure generated by the venturi effect of the ejector 4 to reduce the pressure. Since it is possible to perform pressure reduction of the regenerating-side container 12 by the negative pressure from the venturi effect of the ejector 4, an electric vacuum pump or the like is unnecessary, and it is inexpensive and will not break, and thus it is possible to easily reduce the pressure in the regenerating-side container 12.

(3) The present embodiment is configured to include: the steam channel 43 in which the steam generated by the heat-generating-side container 11 flows and in which the ejector 4 is provided; the check valve 45 arranged near the ejector 4; and the negative-pressure second channel 42 connected from the ejector 4 to between the inside wall 111 and the outside wall 112 of each of the pair of containers 10 via the check valve 45. The air within the double walls of the container 10a is suctioned from the negative-pressure second channel 42 by the negative pressure generated by the venturi effect of the ejector 4 to reduce the pressure. Since it is possible to perform pressure reduction between the inside wall 111 and the outside wall 112 with the negative pressure from the venturi effect of the ejector 4, an electric vacuum pump and the like are unnecessary, and it is inexpensive and will not break, and thus it is possible to easily reduce the pressure in the regenerating-side container 12. In addition, since it is possible reduce the pressure between the double walls and maintain a substantially vacuum state, there is a high insulation property and thermal efficiency becomes favorable. Consequently, a thermal insulator is unnecessary in the pair of containers 10, which facilitates recycling, etc., and thus the environmental impact is reduced.

(4) According to the present embodiment, the thermal storage material 3 is configured from an alkali earth metal. It is configured so that the thermal storage material 3 generates heat by supplying water to the heat-generating-side container 11, thereby heating the regenerating-side container 12, and the hydroxide of the alkali earth metal being oxidized to regenerate the thermal storage material 3. It is configured to include the regeneration steam channel 44 connecting the heat-generating-side container 11 and the regenerating-side container 12, and in which the steam generated from the regenerating-side container 12 flows, and the ejector 4 is provided. The steam is suctioned from the regenerating-side container 12 to the heat-generating-side container 11 by the negative pressure generated from the venturi effect of the ejector 4, and then supplied to the heat-generating-side container 11. The steam generated by the endothermic reaction of the thermal storage material 3 inside the regenerating-side container 12 is reduced in pressure by the ejector 4 and suctioned. Since the steam generated during regeneration of the thermal storage material 3 is emitted to outside of the regenerating-side container 12, the thermal energy required in regeneration becomes smaller, and the temperature required in regeneration also becomes lower. In addition, it is also possible to shorten the time required in regeneration. Furthermore, by the air and/or steam inside of the regenerating-side container 12 being reduced in pressure by the ejector 4, the heat loss of the heated regenerating-side container 12 decreases.

(5) According to the present embodiment, the thermal storage material 3 is configured from a metal oxide which reacts with water, and the heating and supply of water are switched between the pair of containers 10 so that the heat-generating-side container 11 and the regenerating-side container 12 alternate roles with each other. By alternately switching the heat-generating-side container 11 and the regenerating-side container 12, it becomes possible to continuously regenerate and store energy.

(6) The present embodiment is configured to include the water pipe section 5 arranged in each of the pair of containers 10, and capable of circulating the water or hot water and steam inside. During regeneration of the thermal storage material 3, the supply of water to the water pipe section 5 is not carried out in the regenerating-side container 12, and the hot water or steam within the water pipe section 5 is supplied to the water pipe section 5 of the heat-generating-side container 11. The water inside the water pipe section 5 heated during regeneration becomes steam, and is supplied to the water pipe section 5 of the heat-generating-side container 11, whereby it is possible to utilize the heat without waste.

(7) According to the present embodiment, in the production method of the energy storing device 1, the inside wall 111 and outside wall 112 of the double walls are joined with atmospheric pressure therebetween. In the case of each of the pair of containers 10 being large scale, since it is unnecessary to produce a vacuum double-wall container by welding in a reduced-pressure substantially vacuum environment, it becomes possible to reduce the production cost. In addition, there is no need to spend a long time vacuuming inside of the welded vacuum double-walled container.

It should be noted that the present invention is not to be limited to the above-described embodiment, and that modifications, improvements, etc. within a scope that can achieve the object of the present invention are also encompassed by the present invention. For convenience of explanation, the above embodiment is described by illustrating one ejector 4; however, there may be a plurality of the ejectors 4, and may be provided to every negative-pressure channel. In addition, various valves can be provided as necessary in the channels of air, steam, water, etc.

### EXPLANATION OF REFERENCE NUMERALS

1 energy storing device
3 thermal storage material
4 ejector
5 water pipe section
9 piping
10 pair of containers
10a container
11 heat-generating-side container
12 regenerating-side container
41 negative-pressure first channel
42 negative-pressure second channel
43 steam channel
44 regeneration steam channel
45 check valve
111 inside wall
112 outside wall

What is claimed is:

1. An energy storing device comprising a container and a thermal storage material that is accommodated inside of the container and generates heat by way of chemical reaction,
wherein the container comprises a pair of containers, each one being configured by double walls including an inside wall and an outside wall, the pair of containers including a heat-generating-side container in which the thermal storage material generates heat, and a regenerating-side container which regenerates the thermal storage material used in heat generation, and
wherein the pair of containers are connected by piping in which an ejector is provided.

2. The energy storing device according to claim 1, further comprising:
a steam channel in which steam generated by the heat-generating-side container flows, and the ejector is provided; and
a negative-pressure first channel which is connected from the ejector to inside of the regenerating-side container,
wherein air inside of the regenerating-side container is suctioned from the negative-pressure first channel to reduce in pressure by negative pressure generated by venturi effect of the ejector.

3. The energy storing device according to claim 1, further comprising:
a steam channel in which steam generated by the heat-generating-side container flows, and in which the ejector is provided;
a check valve disposed in a vicinity of the ejector; and
a negative-pressure second channel which is connected from the ejector to between the inside wall and the outside wall of each of the pair of containers via the check valve,
wherein air within the double walls of the container is suctioned from the negative-pressure second channel to reduce in pressure by negative pressure generated by venturi effect of the ejector.

4. The energy storing device according to claim 1,
wherein the thermal storage material is an alkali earth metal,
wherein the thermal storage material generates heat in the heat-generating-side container by water being supplied thereto, whereby the regenerating-side container is heated, and a hydroxide of the alkali-earth metal is oxidized to regenerate the thermal storage material,
wherein the energy storing device further comprises a regeneration steam channel which connects between the heat-generating-side container and the regenerating-side container, and in which steam generated from the regenerating-side container flows, and the ejector is provided, and
wherein steam is suctioned from the regenerating-side container to the heat-generating-side container by negative pressure generated by venturi effect of the ejector, and is supplied to the heat-generating-side container.

5. The energy storing device according to claim 1,
wherein the thermal storage material is a metal oxide which reacts with water, and
wherein heating and supply of water to the pair of containers is switched so that the heat-generating-side container and the regenerating-side container alternately change roles.

6. The energy storage device according to claim 5, further comprising a water pipe section disposed in each of the pair of containers, and capable of flowing water or hot water and steam inside,
wherein, during regeneration of the thermal storage material, supply of water to the water pipe section is not performed in the regenerating-side container, and hot water or steam within the water pipe section is supplied to the water pipe section of the heat-generating-side container.

7. A method of producing the energy storing device according to claim 1,
wherein the inside wall and the outside wall of the double walls are joined with atmospheric pressure therebetween.
